(19) United States
(12) Patent Application Publication
(10) Pub. No.: US 2026/0347266 A1
(43) Pub. Date: Nov. 5, 2026

(54) METHODS OF PRODUCING URANIUM-ZIRCONIUM CARBONITRIDE AND RELATED MATERIALS

(71) Applicant: Battelle Energy Alliance, LLC, Idaho Falls, ID (US)

(72) Inventors: Sarah R. Hamilton, Idaho Falls, ID (US); Nathan D. Jerred, Idaho Falls, ID (US); Randall D. Scott, Idaho Falls, ID (US); James M. Zillinger, Roberts, ID (US); David Sanches, Idaho Falls, ID (US)

(21) Appl. No.: 19/486,718

(22) PCT Filed: May 22, 2024
(86) PCT No.: PCT/US2024/030466

§ 371 Date: Nov. 21, 2025

Related U.S. Application Data
(60) Provisional application No. 63/503,671, filed on May 22, 2023.
(60) Provisional application No. 63/571,963, filed on Mar. 29, 2024.

(51) Int. Cl. C04B 35/58; C01G 43/00; C04B 35/645

(52) U.S. Cl. CPC C04B 35/58035; C01G 43/00; C04B 35/645; C01P 2004/03; C01P 2006/80; C04B 2235/3839; C04B 2235/3852; C04B 2235/666; C04B 2235/785

(57) ABSTRACT

A method of producing uranium-zirconium carbonitride comprises combining uranium nitride and zirconium carbide in a die of a sintering assembly, applying pressure to the combined uranium nitride and zirconium carbide with the die, and applying direct current across the combined uranium nitride and zirconium carbide to form uranium-zirconium carbonitride. Another method comprises reacting a uranium-zirconium alloy with a cyanide compound to form uranium-zirconium carbonitride. An additional method comprises combining zirconium, uranium, and carbon under a nitrogen atmosphere in an arc melt caster, heating the zirconium, uranium, and carbon to a temperature of greater than or equal to about 3500 °C to form a melt phase comprising zirconium, uranium, carbon, and nitrogen, and cooling the melt phase to form uranium-zirconium carbonitride. A composition comprising uranium-zirconium carbonitride at a purity of greater than or equal to about 99.5% is also disclosed.

### CROSS-REFERENCE TO RELATED APPLICATIONS

This application is a national phase entry under 35 U.S.C. § 371 of International Patent Application PCT/US2024/030466, filed May 22, 2024, designating the United States of America and published as International Patent Publication WO 2024/243256 A1 on Nov. 28, 2024, which claims the benefit under Article 8 of the Patent Cooperation Treaty to U.S. Patent Application Ser. No. 63/503,671, filed May 22, 2023, and U.S. Patent Application Ser. No. 63/571,963, filed Mar. 29, 2024, the disclosure of each of which is hereby incorporated herein in its entirety by this reference.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

This disclosure relates generally to uranium-zirconium carbonitride (UZrCN) and, more particularly, to a high purity UZrCN and methods of producing the UZrCN.

### BACKGROUND

Uranium-zirconium carbonitride (UZrCN) is a nuclear fuel that has been studied for use in high temperature gas reactors (HTGRs), advanced gas reactors (AGRs), and space nuclear propulsion (SNP). For these applications, the nuclear fuel must withstand high temperatures and also maintain a high thermal conductivity. UZrCN has been produced in small amounts by carbothermal reduction of uranium dioxide and zirconium dioxide. However, the resulting UZrCN has high oxygen contamination, which drastically decreases the thermal conductivity of the UZrCN.

### BRIEF SUMMARY

A method of producing uranium-zirconium carbonitride according to embodiments of the disclosure comprises combining uranium nitride and zirconium carbide in a die of a sintering assembly. Pressure is applied to the combined uranium nitride and zirconium carbide with the die. Direct current is applied across the combined uranium nitride and zirconium carbide to form uranium-zirconium carbonitride.

Another method of producing uranium-zirconium carbonitride according to embodiments of the disclosure comprises reacting a uranium-zirconium alloy and a cyanide compound to form uranium-zirconium carbonitride.

Yet another method of producing uranium-zirconium carbonitride according to embodiments of the disclosure comprises combining zirconium, uranium, and carbon under a nitrogen atmosphere in an arc melt caster. The zirconium, uranium, and carbon are heated to a temperature of greater than or equal to about 3500 °C to form a melt phase comprising zirconium, uranium, carbon, and nitrogen. The melt phase is cooled to form uranium-zirconium carbonitride.

A composition according to embodiments of the disclosure comprises uranium-zirconium carbonitride at a purity of greater than or equal to about 99.5%.

### BRIEF DESCRIPTION OF THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 is a flow diagram showing a method of forming uranium-zirconium carbonitride according to embodiments of the disclosure;

FIG. 2 is a flow diagram showing a method of forming uranium-zirconium carbonitride according to other embodiments of the disclosure;

FIG. 3 is a flow diagram showing a method of forming uranium-zirconium carbonitride according to yet other embodiments of the disclosure;

FIGS. 4A and 4B are images showing diffusion bonding in a zirconium carbide (ZrC) and uranium nitride (UN) pellet formed according to embodiments of the disclosure;

FIG. 5 includes SEM images showing a uranium-zirconium carbonitride (UZrCN) interface region between ZrC and UN;

FIGS. 6A and 6B are EDS images showing a UZrCN interface region between ZrC and UN;

FIG. 7 is a line scan of the interface region between the ZrC and UN of the diffusion couple of FIGS. 6A and 6B;

FIG. 8 includes wave-length dispersive spectrometry (WDS) images demonstrating the migration of carbon, where ZrC was originally on the top of the image and UN was originally positioned the bottom of the image;

FIG. 9 shows locations of a UZrCN interface region between ZrC and UN;

FIGS. 10-12 are SEM image of UZrCN formed by a FAS process according to embodiments of the disclosure; and

FIGS. 13-15 are SEM images of UZrCN formed by a direct casting process according to embodiments of the disclosure.

### DETAILED DESCRIPTION

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, any relational term, such as “first,” “second,” “top,” “bottom,” “upper,” “lower,” “above,” “beneath,” “side,” “upward,” “downward,” etc., is used for clarity and convenience in understanding the disclosure and accompanying drawings, and does not connote or depend on any specific preference or order, except where the context clearly indicates otherwise.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.).

A person of ordinary skill in the art will understand that components (e.g., pipelines, line filters, valves, temperature detectors, flow detectors, pressure detectors, and the like) of some systems and processes are inherently disclosed herein and that adding various conventional process components and acts would be in accord with the disclosure.

Methods of producing uranium-zirconium carbonitride (UZrCN) are disclosed. The methods include a solid-state diffusion process, a gas phase process, and a direct casting process (e.g., an arc melting process) of forming UZrCN. These methods enable the UZrCN to be produced by relatively fast and efficient processes compared to conventional processes (e.g., carbothermal reduction of uranium dioxide and zirconium dioxide) of forming UZrCN. The UZrCN formed by embodiments of the disclosure is an accident tolerant fuel and is formulated to be safer and more resistant to accidents than uranium oxide (UO₂) or uranium nitride (UN). The UZrCN may be produced at a higher purity than with conventional processes of forming UZrCN. For instance, the UZrCN may exhibit relatively lower levels of oxygen contamination than UZrCN formed by conventional processes. By using starting materials that are not metal oxides (e.g., starting materials that are not uranium oxide or zirconium oxide), the resulting UZrCN may be substantially free of oxygen. In some embodiments, the UZrCN includes less than or equal to about 0.5% by mass of oxygen. In other embodiments, the UZrCN includes less than or equal to about 0.1% by mass of oxygen. The UZrCN may, therefore, exhibit a purity of greater than or equal to about 99.9% by mass. The UZrCN may be produced at a high purity and exhibit a substantially homogeneous chemical composition, such as a substantially homogeneous quaternary phase of UZrCN. The resulting UZrCN may be a crystalline material, such as a face centered cubic (FCC) crystal structure. The crystal structure of the UZrCN may vary depending on the process used, which may result in the UZrCN exhibiting different properties depending on the process used in its formation. In some embodiments, the UZrCN exhibits a rock salt structure with disorder on both the cation (uranium, zirconium) and anion (carbon, nitrogen) sublattices. The crystal structure of UZrCN is close-packed in nature and the bonding between atoms is ionic.

By adjusting process parameters of the solid-state diffusion process, the gas phase process, or the direct casting process, a chemical composition (e.g., stoichiometry) of the UZrCN may be tailored to exhibit desired properties. The properties include, but are not limited to, mechanical properties, thermophysical properties, and/or chemical properties. The UZrCN produced according to embodiments of the disclosure exhibits one or more of a higher thermal conductivity, a higher melting point, a higher uranium content, or a greater strength than other nuclear fuels, such as UO₂ or UN. By tailoring the chemical composition of the UZrCN, the UZrCN may be formulated to withstand high temperature environments and to also exhibit a high thermal conductivity in the high temperature environments. The UZrCN may, for example, exhibit a high temperature phase (a melting point of about 3120 K) and a high thermal conductivity (about 32 W/m*K at 2000 K). The carbon and nitrogen may function as an interstitial defect, providing mechanical strength and chemical stability to the UZrCN. The UZrCN may also be resistant to extreme environments that include one or more of hydrogen, helium, or carbon dioxide at a temperature between about 1000 K and about 2900 K, which are prototypic for nuclear reactor environments that use hydrogen, helium, or carbon dioxide as coolants or propellants. The UZrCN may also be resistant to a temperature between about 2400 K and about 3500 K, which are operation temperatures of nuclear thermal rockets.

The chemical composition of the UZrCN produced by the methods according to embodiments of the disclosure may range from U_{0.1}Zr_{0.9}(C_{0.1}N_{0.9}) to U_{0.9}Zr_{0.1}(C_{0.9}N_{0.1}). For example, the UZrCN may be U_{0.2}Zr_{0.8}(C_{0.5}N_{0.5})_{0.98}, U_{0.9}Zr_{0.1}(C_{0.5}N_{0.5})_{0.96}, U_{0.9}Zr_{0.1}(C_{0.44}N_{0.56})_{0.71}, U_{0.9}Zr_{0.1}(C_{0.47}N_{0.53})_{0.9}, U_{0.9}Zr_{0.1}(C_{0.62}N_{0.38})_{0.97}, U_{0.9}Zr_{0.1}(C_{0.66}N_{0.34})_{0.99}, U_{0.9}Zr_{0.1}(C_{0.4}N_{0.6})_{0.99}, U_{0.9}Zr_{0.1}(C_{0.47}N_{0.49}), or U_{0.9}Zr_{0.1}(C_{0.62}N_{0.38})_{0.98}. In some embodiments, the UZrCN is a quaternary phase (e.g., U_{0.25}Zr_{0.25}C_{0.25}N_{0.25}) or a substantially quaternary phase (e.g., U_{29.9}Zr_{24.8}C_{24.9}N_{20.5} or U_{27.3}Zr_{27.9}C_{22.8}N_{21.2}). For some applications, a high uranium density may be desired, such as a density of greater than or equal to 8.0 g/cm³. In some embodiments, the uranium density is greater than or equal to 12.1 g/cm³. In such embodiments, the UZrCN is U_{0.9}Zr_{0.1}CN. The properties of the UZrCN may depend on relative ratios of uranium atoms, zirconium atoms, carbon atoms, and nitrogen atoms present in the UZrCN. By way of example only, the properties of the UZrCN may largely depend on relative amounts of the uranium atoms and zirconium atoms present, with the carbon atoms and nitrogen atoms in interstitial spaces between the uranium atoms and zirconium atoms. The carbon atoms and nitrogen atoms may migrate through the uranium atoms and zirconium atoms due to their relatively smaller atomic radii.

The UZrCN according to embodiments of the disclosure may be produced by a solid-state diffusion reaction between uranium nitride (UN) and zirconium carbide (ZrC). The UZrCN may be produced by a field-assisted sintering (FAS) process (e.g., an electrical field-assisted sintering process (EFAS)), which relies on substitutional and interstitial diffusion of the uranium atoms, zirconium atoms, nitrogen atoms, and carbon atoms, as well as the advanced diffusion behavior caused by electrical field sintering. The FAS process drives both diffusion mechanisms, but compared to conventional sintering methods, the FAS process may enhance the diffusion mechanisms to enable the sintering on much shorter timescales.

The FAS process includes combining a first material (e.g., uranium nitride) and a second material (e.g., zirconium carbide) and placing the mixture in a die of a FAS system. Combining the UN and ZrC may enable more diffusion surface areas to be exposed during the FAS process, resulting in a more homogeneous UZrCN. A powder, such as a powdered alloy, of each of the UN and the ZrC may be used in the solid-state diffusion reaction. The UN and ZrC may be substantially pure, such as exhibiting a purity of greater than or equal to about 95% by weight. For instance, each of the UN and ZrC may have less than about 500 parts per million (ppm) of impurities.

The powders of UN and ZrC may exhibit an average particle size of less than about 1 mm. For example, the powders of UN and ZrC may exhibit average particle sizes of between about 110 nm and about 300 micron (μm), such as between about 50 μm and about 150 μm, between about 75 μm and about 150 μm, between about 100 μm and about 150 μm, between about 50 μm and about 100 μm, between about 100 μm and about 250 μm, between about 100 μm and about 200 μm, between about 200 μm and about 300 μm, between about 200 μm and about 275 μm, between about 200 μm and about 250 μm, between about 225 μm and about 275 μm, or between about 250 μm and about 275 μm. The UN and ZrC may be independently selected to exhibit the same particle size or exhibit different average particle sizes. Nanometer particle sizes of the UN and ZrC may also be used, such as being less than about 1000 nm. By way of example only, the particles may be from about 10 nm to about 800 nm, from about 20 nm to about 500 nm, or from about 40 nm to about 200 nm. Without being bound by any theory, using relatively smaller particle sizes of the UN and the ZrC may increase interactions between the UN and the ZrC, enabling a more homogeneous UZrCN material to be produced. In some embodiments, the ZrC exhibits an average particle size of less than about 200 μm. A feedstock for the FAS process may be selected in terms of particle size and particle size distribution to control the reaction and stoichiometry, producing a substantially homogeneous chemical composition of the UZrCN.

The powders of UN and ZrC may be prepared by atomization, milling, or other techniques for producing the desired particle size. For example, the powder may be produced by ball milling, hammer milling, gas atomization, hydride-dehydride-nitride, or rotating electrode atomization processes. Fuel rods or pellets (e.g., UN fuel rods/UN pellets) may, for example, be milled to the desired particle size. Alternatively, the fuel rods may be used in an atomizer. The particles of UN and ZrC may be semi-spherical, substantially spherical (e.g., a kernel), or may exhibit an angular morphology. Using an angular morphology of the UN and ZrC powders is believed to provide an increased diffusion surface area, which enables a substantially homogeneous chemical composition of the UZrCN to be produced.

Relative amounts of the UN and ZrC used in the solid-state diffusion reaction may be selected depending on the desired chemical composition of the UZrCN. By way of example only, from about 10 atomic percent % (at. %) to about 70 at. % of the UN may be present in a mixture of the UN and ZrC, such as from about 15 at. % to about 60 at. %., from about 15 at. % to about 55 at. %, or from about 15 at. % to about 50 at. %. The ZrC may be present in the mixture of the UN and ZrC at from about 30 at. % to about 90 at. %, such as from about 40 at. % to about 85 at. %., from about 45 at. % to about 85 at. %, from about 50 at. % to about 85 at. %, or from about 55 at. % to about 85 at. %.

The die containing the mixture of the UN and ZrC is placed in an apparatus (e.g., the field-assisted sintering system) that includes a system controller and a current controller operably coupled to the die and configured to apply electrical current to the die. The apparatus may also include a mechanism for applying pressure, such as, for example, a pneumatic system or a hydraulic system. An electrical current (e.g., current density) and pressure (e.g., a compressive force) are applied to the die containing the mixture, such as to an upper punch and a lower punch of the die, during the FAS process. The application of the electric current and pressure heats the UN and ZrC powders and increases diffusion behavior. The electric current may be applied before the pressure, substantially simultaneously with the pressure, or after the pressure. The electrical current may be applied as a pulse. The electrical current and pressure are maintained at a substantially constant electrical current and pressure for a pre-determined amount of time (e.g., hold time). Alternatively, the electrical current is adjusted to maintain a constant temperature. The magnitude of the electrical current that flows through the upper punch and the lower punch and consequently, the UN and ZrC materials, depends on the desired temperature to which the mixture of UN and ZrC is to be heated.

The apparatus also includes an upper electrode and a lower electrode for conducting the electrical current. The electrical current applied to the upper and lower electrodes may be initiated by the current controller. The electric current applied to the punch (e.g., upper punch, lower punch) may range from about 1000 amps (A) to about 150,000 A, such as from about 1240 A to about 48,000 A, from about 1300 A to about 46,000 A, from about 1325 A to about 42,000 A, from about 10,000 A to about 50,000 A, from about 20,000 A to about 50,000 A, from about 30,000 A to about 50,000 A, from about 40,000 A to about 50,000 A, or from about 45,000 A to about 50,000 A. The electrical current may be selected depending on the dimensions and other properties of the UN and the ZrC, as well as on dimensions and materials of the die. The pressure applied to the die may range from about 10 mega pascals (MPa) to about 200 MPa, such as from about 10 MPa to about 40 MPa, from about 10 MPa to about 30 MPa, from about 10 MPa to about 20 MPa, from about 20 MPa to about 40 MPa, from about 20 MPa to about 30 MPa, or from about 40 MPa to about 80 MPa. In some embodiments, a pressure of about 40 MPa is applied to the die containing the UN and ZrC mixture. Such field-assisted sintering systems are known in the art and may be commercially available. By way of example only, the FAS assembly may be a DSC-25 system available from Thermal Technology, which is capable of providing up to about 25 tons of force and up to 10,000 amps. However, the FAS assembly may be smaller or larger depending on the scale of material to be produced.

The temperature to which the powders of UN and ZrC (e.g., the UN and ZrC mixture) are heated during the solid-state diffusion reaction may be from about 800 °C to about 2500 °C, such as from about 1200 °C to about 2500 °C, from about 1500 °C to about 2000 °C, from about 1800 °C to about 2200 °C, from about 2000 °C to about 2500 °C, from about 1800 °C to about 2200 °C, from about 1800 °C to about 2100 °C, from about 1800 °C to about 2000 °C, or from about 1800 °C to about 2100 °C. The UN and ZrC mixture may be heated to the desired temperature at a constant rate or may be heated step wise to one or more intermediate temperatures before reaching a maximum temperature (e.g., the desired temperature). The temperature of the mixture may also be reduced to one or more intermediate temperatures before returning to the maximum temperature. In some embodiments, the UN and ZrC mixture is heated to a temperature of about 1800 °C. In other embodiments, the UN and ZrC mixture is heated to a temperature of about 2100 °C. In yet other embodiments, the UN and ZrC mixture is heated to a temperature of about 2200 °C. The UN and ZrC mixture may be heated to the desired temperature at a rate of from about 50 °C/min to about 800 °C/min, such as from about 100 °C/min to about 500 °C/min. The UN and ZrC may be heated to the desired temperature for between about 1 minute and about 60 minutes, such as between about 1 minute and about 30 minutes between about 5 minutes and about 25 minutes, between about 5 minutes and about 20 minutes, between about 5 minutes and about 15 minutes, between about 5 minutes and about 10 minutes, between about 10 minutes and about 25 minutes, between about 15 minutes and about 25 minutes, or between about 15 minutes and about 20 minutes.

Following the application of electrical current and pressure to the die for a sufficient amount of time, the powders of UN and ZrC react (e.g., are sintered) to form the UZrCN according to embodiments of the disclosure. The UZrCN may be allowed to cool and then removed from the die. The FAS process may be used to form the high purity UZrCN having a substantially homogeneous chemical composition, such as a substantially homogeneous quaternary phase of UZrCN. In some embodiments, the resulting UZrCN is a quaternary phase of UZrCN. However, other chemical compositions of UZrCN, such as those previously described, may be produced. The UZrCN includes less than or equal to about 0.5% by mass of oxygen since no metal oxides as used as starting materials. Diffusion bonding achieved during the sintering may provide additional adhesion support between the fuel (UN) and the matrix (ZrC), reducing or eliminating delamination of the UZrCN at high temperatures.

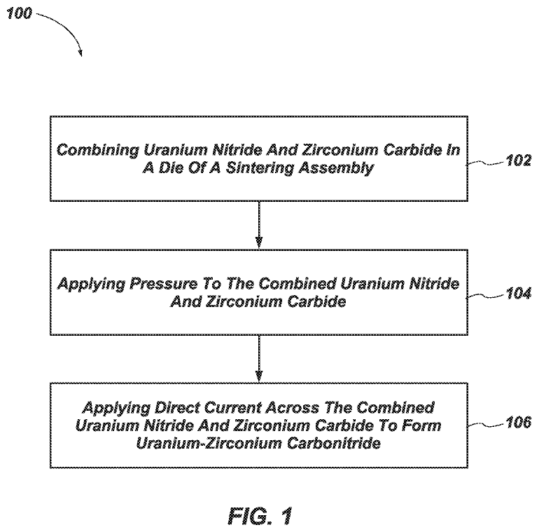

The UZrCN according to embodiments of the disclosure may be produced by a solid-state diffusion reaction between UN and ZrC. As shown in FIG. 1, process 100 includes act 102 of combining UN and ZrC in a die of a sintering assembly. Pressure is applied to the combined UN and ZrC in act 104, and direct current is applied across the combined UN and ZrC in act 106 to form the UZrCN.

The UZrCN according to embodiments of the disclosure may also be produced by a gas phase reaction of a uranium-zirconium (UZr) material (e.g., a uranium-zirconium alloy) and a cyanide compound. The stoichiometry of the UZrCN may be controlled by adjusting one or more of a relative ratio of the UZr material and the cyanide compound, a reaction pressure, a reaction temperature, a flow rate of the cyanide compound, and a particle size of the UZr material. Reacting the UZr material and the cyanide compound may proceed according to the following reactions, where hydrogen cyanide (HCN) or cyanogen (CN) 2 is used as the cyanide compound:

$$2 HCN + 2 UZr ↔ 2 UZrCN + {H}_{2}$$

$${( CN )}_{2} + 2 UZr ↔ 2 UZrCN$$

The cyanide compound may be in a gaseous state under the reaction conditions. The gas phase reaction may be conducted in a reaction vessel configured to contain the UZr material and the cyanide compound. The reaction vessel and any associated components may be substantially inert to the starting materials, reagents, and reaction conditions. For instance, the reaction vessel and components may be formed of stainless steel or other substantially inert material. A source of the cyanide compound may be coupled to the reaction vessel by piping to introduce the cyanide compound to the reaction vessel, which contains the UZr material. The cyanide compound may be introduced to the reaction vessel through an inlet valve. The UZr material and the cyanide compound may be reacted in an inert atmosphere, with one or more inert gases introduced to the reaction vessel through, for example, a valve. The reaction vessel may, optionally, include a stirrer motor to combine the UZr material and the cyanide compound. The reaction vessel may also include appropriate safety and environmental components for controlling the purity and pressure of the cyanide compound to ensure safe operation. During the reaction, carbon atoms and nitrogen atoms may migrate through a lattice structure of the UZr due to the relatively smaller atomic radii of carbon and nitrogen atoms. Since interstitial diffusion of carbon atoms and nitrogen atoms occurs during the gas phase reaction, the resulting UZrCN is produced by a relatively fast and efficient process that also enables the stoichiometry of the UZrCN to be controlled. After conducting the gas phase reaction, the UZrCN is subsequently recovered from the reaction vessel.

The UZr material may react with the cyanide compound, such as a gaseous cyanide compound, under the reaction conditions to produce the high purity UZrCN, which is substantially free of oxygen contamination. In some embodiments, the UZrCN includes less than or equal to about 0.5% by mass of oxygen. In other embodiments, the UZrCN includes less than or equal to about 0.1% by mass of oxygen.

The UZr material may be a UZr powder, such as an atomized UZr powder. The UZr material may be formed using rotating electrode atomization, gas atomization, cryo-milling, or hydride-dehydride-nitride processes, such as from an available feedstock of UZr. Fuel rods (e.g., UZr fuel rods) may, for example, be milled to the desired particle size. The UZr material may exhibit a powder size (e.g., a particle size) within the particle size ranges described above for the solid-state diffusion reaction, including nanometer sized particles. Using the nanometer sized particles may improve diffusion. For example, the UZr may exhibit a powder size (e.g., a particle size) of less than about 150 μm if an angular morphology is used or a size (e.g., a particle size) of between 225-275 μm if the UZr is substantially spherical (e.g., a kernel). A relatively small particle size of the UZr material may be used to enable the cyanide compound to penetrate further into a mass of the UZr material. In some embodiments, the UZr material is an atomized UZr powder. The particle size of the UZr may, however, be changed depending on other parameters of the gas phase reaction.

The UZr material may react with the cyanide compound during the gas phase reaction process, with the cyanide compound being gaseous under the reaction conditions. The cyanide compound may include, but is not limited to, hydrogen cyanide (HCN), cyanogen (CN₂), or a combination thereof. The cyanide compound may be commercially available from numerous sources. If HCN is used as the cyanide compound, excess hydrogen produced during the reaction may be removed, such as by burning or by using a getter, such as titanium. If cyanogen is used as the cyanide compound, the process may be a less complex process since no hydrogen is produced and, therefore, no hydrogen needs to be removed.

Process parameters within the reaction vessel may be adjusted to control the stoichiometry of the UZrCN. For instance, the pressure and temperature within the reaction vessel may be adjusted. The pressure within the reaction vessel may be atmospheric pressure or may be up to about 100 psig (up to about 790.8 kPa). The temperature at which the gas phase reaction is conducted may be at or above a boiling point (e.g., a vaporization point) of the cyanide compound. The UZr material and the cyanide compound may be combined with agitation to expose additional surface area of the UZr material to the cyanide compound. The relative ratios of the UZr material and the cyanide compound may be tailored by adjusting the flow rate of the cyanide compound and reaction mass of the UZr material to control the stoichiometry of the UZrCN.

Diffusion behavior of the UZr material and the cyanide compound may be predicted through computational modeling by determining energy barriers to diffusion. The energetics of the breakup of the cyanide compound (e.g., HCN, CN₂) on the (001), (110) and (111) surfaces of UZr and the energy barriers of the dominant diffusing species to penetration into the surface may be determined by the modeling, which may be used to generate process parameters that form high purity UZrCN.

While the gas phase reaction uses a gas as the cyanide compound, a solid cyanide compound may alternatively be used. For instance, a cyanide salt may be used, such as sodium cyanide, potassium cyanide, calcium cyanide, or combinations thereof. The cyanide salt may be dissolved in an organic solvent or an aqueous based solvent and reacted with the UZr material. The cyanide salt may be less reactive with the UZr material than the gaseous cyanide compound. However, by adjusting the reaction conditions, such as temperature or pressure, the UZr material and cyanide salt may react to form the UZrCN.

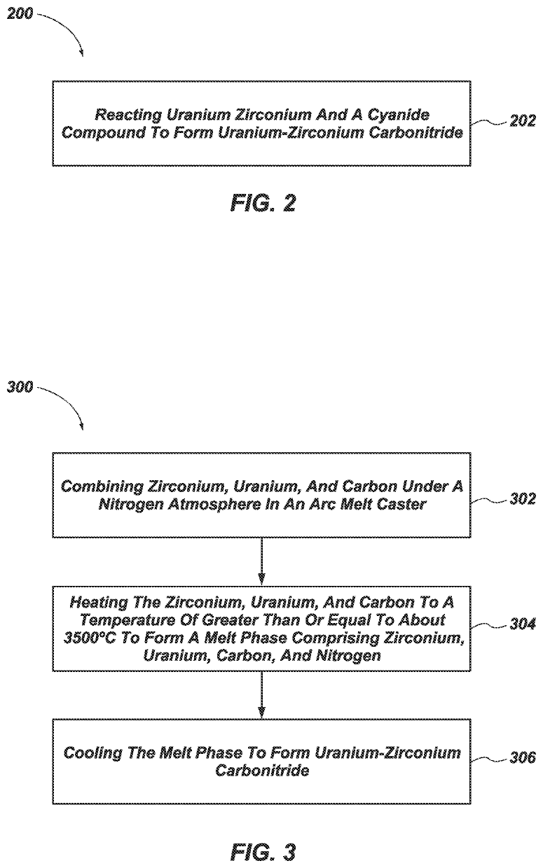

The UZrCN according to embodiments of the disclosure may be produced by a gas phase reaction of a UZr material and a cyanide compound. As shown in FIG. 2, process 200 includes act 202 of reacting UZr and the cyanide compound to form the UZrCN.

The UZrCN according to embodiments of the disclosure may also be formed by a direct casting process. The direct casting process may include, but is not limited to, an arc melting process. The direct casting process combines zirconium, uranium, and carbon under a nitrogen atmosphere and at a high temperature to form an alloy of the UZrCN. By controlling the relative amounts of zirconium, uranium, carbon, and nitrogen, a desired stoichiometry of the UZrCN is achieved. The arc melting process utilizes a high current, electrical arc to melt (e.g., liquify) the zirconium, uranium, and carbon and alloy the constituent elements (e.g., the zirconium, uranium, carbon, and nitrogen). During the arc melting process, a temperature of greater than or equal to about 3226.15 °C (about 3500 K), such as greater than or equal to about 3500 °C (about 3773.15 K) may be achieved, sufficient to alloy the zirconium, uranium, carbon, and nitrogen. The high temperature directly alloys the zirconium, uranium, carbon, and nitrogen using the heat generated by the electrical arc and the thermodynamic stability of the UZrCN phase to drive the reaction. The arc melting process quickly heats the zirconium, uranium, and carbon to a molten (e.g., melt) or near molten phase under a nitrogen partial pressure, enabling the melt phase to homogenize and form the alloy. The melt phase is then quickly cooled to form the UZrCN. Other direct casting processes, such as induction casting processes, may also be used to form the UZrCN.

High purity, solid forms of zirconium, uranium, and carbon may be used in the arc melting process, such as foils, films, chips, pellets, chunks, strips, flakes, or a combination thereof. The zirconium and carbon may be commercially available from numerous sources. The carbon may be a high melting point carbon material, such as graphite. The zirconium may also exhibit a high melting point. The solid forms of the zirconium, uranium, and carbon may exhibit a high purity. Nuclear grade zirconium and uranium may be used, such as exhibiting greater than or equal to about 95% by weight zirconium or uranium, greater than or equal to about 98% by weight zirconium or uranium, or greater than or equal to about 99% by weight zirconium or uranium.

The nitrogen atmosphere may include nitrogen gas (N₂) or a combination of N₂ and an inert gas. The inert gas may be argon, helium, or a combination thereof. The N₂ or N₂ and inert gas are collectively referred to herein as a nitrogen cover gas. The N₂ and inert gas may be substantially pure, such as containing little or substantially no oxygen.

The constituent elements may be directly cast in an arc melt caster. The arc melt caster may be commercially available and includes a chamber, a vessel (e.g., a hearth) to contain the zirconium, uranium, and carbon and the melt phase, a power supply to produce the electrical arc, a gas inlet to introduce the nitrogen cover gas, and a vacuum system to evacuate the chamber of reactive gases, such as oxygen. Other systems, such as a cooling system, may be present in the conventional arc melt caster. The high current electrical arc may be produced, for example, by a welding power supply. In some embodiments, the electrical arc is produced with a tungsten stinger/electrode or a carbon electrode. However, other electrode materials may be used, such as zirconium or graphite. The electrical arc may be produced by a 300 A welding power supply. However, a higher or lower amperage power supply may be used. The electrical arc may be produced by a power supply configured to provide up to about 10 kA. The arc current of the power supply may be selected depending on the temperature to be achieved within the chamber. The arc current may be adjusted during the arc melting process to control a size of the arc, which increases or decreases the temperature within the chamber. The temperature within the chamber may be increased during the arc melting process to gradually heat the zirconium, uranium, and carbon while flowing the nitrogen cover gas, which may form the melt phase.

The zirconium, uranium, and carbon are introduced to the hearth of the arc melt caster. The order of introducing the constituent elements to the hearth of the arc melt caster may be varied to achieve the high purity, homogeneous UZrCN. For example, an alloy of UZr may first be introduced to the hearth, followed by the introduction of nitrogen, which is followed by the introduction of carbon. Alternatively, an alloy of UZr may first be introduced to the hearth, followed by the introduction of nitrogen and carbon. Alternatively, an alloy of UZrC may first be introduced to the hearth, followed by the introduction of nitrogen. Other alloys, such as UN or ZrC, may be used in place of the UZr.

Relative amounts (e.g., masses) of the zirconium, uranium, and carbon are selected depending on the desired chemical composition (e.g., stoichiometry) of the UZrCN to be produced. The desired amounts of the zirconium, uranium, and carbon solids may be arranged in the hearth in a random configuration or in an ordered configuration, such as in one or more regions of the hearth. Regions of the zirconium, uranium, and carbon solids may be arranged, such as in alternating regions or other patterns. By way of example only, a sandwich structure of the zirconium, uranium, and carbon solids may be arranged, such as by positioning the carbon solids between the zirconium and the uranium solids. Alternatively, the zirconium and uranium solids may be placed over (e.g., cover) the carbon solids. The zirconium, uranium, and carbon solids may be positioned in the hearth before introducing the nitrogen cover gas to the chamber through a gas line or the nitrogen cover gas may be introduced into the chamber at substantially the same time as the melt phase of zirconium, uranium, and carbon is formed.

The high current, electrical arc is struck, the heat from which heats the constituent elements, such as zirconium, uranium, and carbon, to a temperature sufficient to form the melt phase and alloy the constituent elements. A desired nitrogen partial pressure is maintained in the chamber by introducing the nitrogen cover gas at an appropriate flow rate. The nitrogen partial pressure in the chamber may be up to about 50 psi (up to about 344.7 kilopascal). In addition to providing a source of nitrogen atoms, the nitrogen cover gas may assist in combining the zirconium, uranium, and carbon as the melt phase forms by using a relatively high flow rate of the N₂. In some embodiments, the N₂ flow rate ranges from about 1.0 L/min to about 5.0 L/min, such as from about 1.0 L/min to about 4.0 L/min, from about 1.0 L/min to about 3.0 L/min, from about 1.0 L/min to about 2.0 L/min, from about 2.0 L/min to about 5.0 L/min, from about 3.0 L/min to about 5.0 L/min, or from about 4.0 L/min to about 5.0 L/min. However, lower flow rates or higher flow rates, such as up to about 100 L/min, may be used. The nitrogen cover gas may be introduced into the chamber at substantially the same time as the electrical arc is struck, or the nitrogen cover gas may be introduced into the chamber after forming the melt phase that includes, for example, the zirconium, uranium, and carbon. The temperature within the chamber may be maintained for a sufficient amount of time to melt and alloy the constituent elements. The melt time may be between about 1 minute and about 120 minutes, such as between about 1 minute and about 5 minutes, between about 1 minute and about 10 minutes, between about 1 minute and about 20 minutes, between about 1 minute and about 30 minutes, between about 1 minute and about 60 minutes, or between about 1 minute and about 90 minutes. In some embodiments, the amount of time is from about 1 minute to about 5 minutes.

The flow rate of the nitrogen cover gas is selected depending on the desired chemical composition (e.g., stoichiometry) of the UZrCN and the reaction rate. The flow rate of the nitrogen cover gas may be adjusted to achieve the desired nitrogen partial pressure in the chamber, which affects the reaction rate and the chemical composition (e.g., stoichiometry) of the resulting UZrCN. The flow rate of the nitrogen cover gas may be selected to provide sufficient time for the nitrogen to be incorporated into the melt phase. Increasing the flow rate of the nitrogen cover gas increases the reaction rate and incorporates additional nitrogen into the UZrCN compared to using a slower flow rate of the nitrogen cover gas.

During the arc melting process, the heat from the electrical arc melts the zirconium, uranium, carbon and alloys the zirconium, uranium, carbon, and nitrogen. By using a gaseous form of nitrogen, the nitrogen is more reactive than if nitrogen in a solid form or a liquid form was used. The gaseous nitrogen enables the nitrogen to be easily incorporated and alloyed with the zirconium, uranium, and carbon. Carbon may be relatively harder to incorporate in the melt phase than the zirconium, uranium, and nitrogen. However, by maintaining the carbon in solution in the melt phase, the UZrCN having the desired chemical composition may be formed. Multiple cycles of melting may be conducted to achieve the melt phase that is substantially homogeneous in chemical composition. The melt phase may then be cooled to form the UZrCN having a substantially homogeneous chemical composition, which corresponds in chemical composition to the substantially homogeneous chemical composition of the melt phase. The arc melting process produces a high purity, UZrCN material by controlling the atmosphere within the arc melt caster and the flow rate of the nitrogen cover gas, which enables the desired UZrCN stoichiometry to be produced. The UZrCN may be recovered following the arc melting process.

The UZrCN according to embodiments of the disclosure may also be formed by a direct casting process. As shown in FIG. 3, process 300 includes act 302 of combining zirconium, uranium, and carbon under a nitrogen atmosphere in an arc melt caster. The zirconium, uranium, and carbon are heated in act 304 to a temperature of greater than or equal to about 3500 °C to form a melt phase comprising zirconium, uranium, carbon, and nitrogen. The melt phase is cooled in act 306 to form the UZrCN.

The UZrCN produced by the solid-state diffusion process, the gas phase process, or the direct casting process may, optionally, be subjected to post-sintering anneal acts to further increase the homogeneity of the UZrCN. The post-sintering anneal acts may induce further diffusion.

The UZrCN according to embodiments of the disclosure is durable, thermally stable, and thermally conductive. The UZrCN may, for example, exhibit a melting point of about 3120 K, a thermal conductivity of about 32 W/m*K, an operating temperature of about 2900 K, a uranium content of about 12.5 g/cm³, and an ultimate strength of about 1500 MPa. In comparison, uranium dioxide exhibits a melting point of about 3100 K, a thermal conductivity of about 3 W/m*K, an operating temperature of about 2200 K, a uranium content of about 9.7 g/cm³, and an ultimate strength of about 500 MPa and uranium nitride exhibits a melting point of about 3120 K, a thermal conductivity of about 28 W/m*K, an operating temperature of about 1700 K, a uranium content of about 13.5 g/cm³, and an ultimate strength of about 1950 MPa. The UZrCN is, therefore, formulated to withstand high heat (a temperature between about 1000 K and about 2900 K) and flow of gas coolant, such as helium, hydrogen, and carbon dioxide. The resistance to extreme environments that include one or more of hydrogen, helium, or carbon dioxide may be determined by modeling to predict interactions between the UZrCN and hot gas flow. In addition, the UZrCN according to embodiments of the disclosure may be economically competitive with fossil fuels and other clean energy sources.

The UZrCN according to embodiments of the disclosure may be used in high temperature gas reactors (HTGR), advanced gas reactors, or space nuclear propulsion. The UZrCN may, for example, be used as a fuel. The UZrCN may, for example, be configured as pellets for use in a nuclear reactor, with the pellets exhibiting a substantially homogeneous chemical composition and a high purity of the UZrCN. The UZrCN may also be used as a fuel core in tristructural isotropic (TRISO) particles. However, the UZrCN may be formed into other configurations. The UZrCN may improve efficiency in-core efficiency of the nuclear reactor. The methods of producing the UZrCN according to embodiments of the disclosure may be more efficient than forming UZrCN by carbothermal reduction of uranium dioxide and zirconium dioxide, which reduces the costs of operating a nuclear reactor. The methods may also be able to produce UZrCN at large scale. The resulting UZrCN may exhibit an exceptionally high operating temperature and thermal conductivity, which are highly desirable to improve nuclear reactor economics and safety. The UZrCN according to embodiments of the disclosure may also be resistant to hot gases produced during space nuclear propulsion, which uses a corrosive liquid hydrogen propellant and high temperature to produce thrust. The UZrCN may be resistant to the flow of the hot hydrogen propellant. The UZrCN may also be resistant to flow of a gas coolant, such as helium, hydrogen, and carbon dioxide. The UZrCN according to embodiments of the disclosure may also diffuse heat more effectively than other uranium-based fuels, enabling the nuclear reactor or a nuclear thermal rocket to operate at higher temperatures and have a higher power output without risk of the fuel melting.

The following examples serve to explain embodiments of the disclosure in more detail. These examples are not to be construed as being exhaustive or exclusive as to the scope of this disclosure.

### Example 1

### Formation of UZrCN by FAS

### General Testing Procedures

To investigate diffusion behaviors of UN and ZrC, diffusion couple and composite samples were prepared by FAS. Angular UN powder and kernel UN powder were obtained. The angular fuel had a particle size of less than 150 μm while the kernel fuel size was between 225-275 μm. The ZrC powder was sourced from Alfa Aesar and had a low hafnium content (less than 200 ppm/kg) and an average particle size of less than 200 μm. The ZrC was used as received. The FAS assembly used in this study was a Thermal Technology DSC-25, which is capable of providing up to about 25 tons of force and up to 10,000 amps. The punches and dies used in the DSC-25 were procured from Electrodes, Inc. with an I-82 grade. This grade of graphite was selected to withstand the high temperature (1800 °C-2200 °C) and pressure (40 MPa-80 MPa) of the FAS assembly. The diameter of the resulting samples was 12 mm and approximately 3 mm in height. The UN and ZrC powders were sintered utilizing the electric field of the DSC, which provides many adjustable variables such as the furnace hold time, pressure, ramp rates, hold temperature, and axial load delivered to the powder compact.

The powders of the UN and ZrC were made into samples of pure UN and ZrC using the FAS to study the linear diffusion behavior across the interface between the UN and the ZrC. The samples chosen for the diffusion experiments were all greater than 90 percent theoretical density and were manufactured within a glovebox under an inert atmosphere to reduce oxidation. After manufacturing, the pure UN and ZrC samples were prepared for the diffusion couple by polishing the surfaces to 1 μm using a mechanical polisher. The surfaces were thoroughly cleaned using acetone and ethanol before assembly. Once cleaned, the polished surfaces were put into contact and loaded into a graphite die for heat treatment. Graphite foil was used to protect the samples from bonding with the die and punches and makes the disassembly process easier. The DSC-25 was used to perform the heat treatment due to its floating hydraulic ram design, which creates a dynamic diffusion couple to accommodate the thermal swelling of the materials while applying a constant pressure of 10 MPa.

To evaluate the diffusion behavior of both the diffusion couples and the composite samples described, multiple characterization methods were employed. To perform preliminary microscopic examination, each sample was prepared by mounting a cross section in epoxy and mechanically polishing to 1 μm. The initial characterization was conducted by scanning electron microscopy (SEM) and energy-dispersive x-ray spectroscopy (EDS) techniques to determine if a reaction occurred and if there was a new phase forming. The SEM/EDS is an initial testing step to demonstrate that a reaction has occurred before utilizing more advanced and quantitative analysis techniques. The SEM was performed with a JSM-IT500HR scanning electron microscope and the EDS was performed with an Oxford Ultim Max 65 EDS. However, these methods could not be used to quantitatively determine the behavior of the light elements (carbon and nitrogen) because of their small electron clouds. To get a more accurate depiction of the carbon and nitrogen migration, an Oxford Wave wave-length dispersive spectrometry (WDS) was used for confirmation. The samples were further characterized using X-ray diffraction (XRD), atom probe tomography (APT) and transmission electron microscopy (TEM) to confirm the phase and composition of the material.

To evaluate the interaction on a nanoscopic scale, scanning transmission electron microscopy (STEM) and atom probe tomography (APT) were also employed. The STEM used was an FEI Titan Themis G2 200 Cs Corrected scanning transmission electron microscope. The diffraction patterns provided by the STEM were used to classify the crystal structure and lattice parameter of the interaction regions. APT was used to elucidate the microstructural and chemical analysis from the UN/ZrC composite. APT is a unique nanoscale characterization tool wherein each atom is field evaporated from the needle shaped specimen subjected to high electric field. The APT will quantify the atom percent of each constituent (uranium, zirconium, carbon, and nitrogen) by field evaporating each atom and projecting them directly onto a detector. This is the most accurate way to quantify the light elements (carbon and nitrogen) and determine the atomic ratio that has been achieved. In the case of ceramics, laser assisted APT offers a viable option to achieve near accurate quantification of chemistry. The specimens for APT were prepared from the diffusion zone between the UN and ZrC to determine the composition and complement the structural information gained through TEM analysis. The Selected Area Electron Diffraction (SAED) technique will be employed on the TEM as a nanoscale diffraction method that will complement the XRD results and determine the crystal structure of the resultant sample on the nanometric level. The combined results of the TEM and APT will indicate the successfulness of the synthesis method used. On the nanoscale, UZrCN has a well-known face-centered cubic rock salt structure that is easily identifiable with TEM/SAED. APT analysis was performed using a LEAP 5000 instrument. The needle shaped specimens from the UN/ZrC composite for APT analysis were prepared using dual beam focus ion beam (FIB) quanta by lift-out procedure. Specimens were run in laser mode with a laser energy of 50-100 pJ, a base temperature of 55 K, a detection rate of 0.5 at. %, and a pulse repetition rate of 125 KHz. All APT data sets were reconstructed and analyzed using Integrated Visualization and Analysis Software (IVAS), version 3.8.10. A Thermo Scientific™ Helios™ Hydra G4 focused ion beam (FIB) was used to create the lamella and cones for the TEM and APT.

### Diffusion Couples

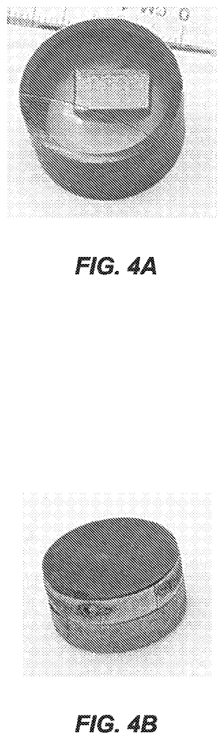

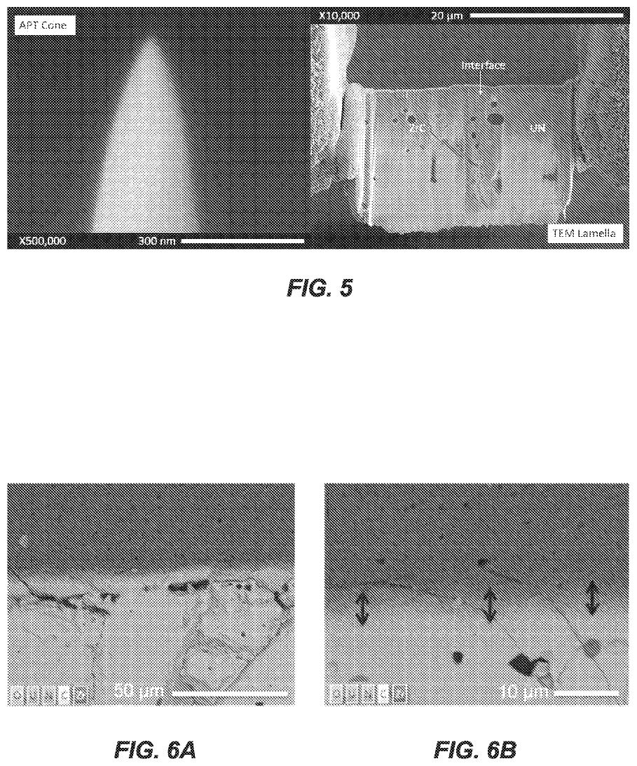

The diffusion couples were heat treated at 1800 °C for 1 hour. Two FAS diffusion couple samples were examined using SEM/EDS to do a preliminary evaluation of the interaction boundary (e.g., the UN/ZrC boundary). The diffusion couple samples included UN and ZrC discs and were heated in the DSC-25. During the heating, the samples were able to expand as necessary while still keeping the samples in close contact. Both samples were run with identical parameters but the samples differed in densities of the ZrC and UN. The temperature and pressure used in this experiment were sufficient to induce diffusion bonding, as shown in FIGS. 4A and 4B. FIG. 4A shows a diffusion couple between a UN sintered compact and a ZrC sintered compact, and FIG. 4B shows diffusion bonding between the UN and ZrC. After heat treatment, the diffusion couples were sectioned in a high-speed saw to expose the diffusion interface (e.g., interface region, diffusion zone). A layer of graphite punch was left to provide an anchor for the sectioning process. The samples included a diffusion region of 2 μm-5 μm after bonding. As shown in FIG. 5, an interface, indicated by the arrow, formed between the ZrC (lefthand side) and the UN (righthand side). STEM results showed that the phase at the interface was FCC.

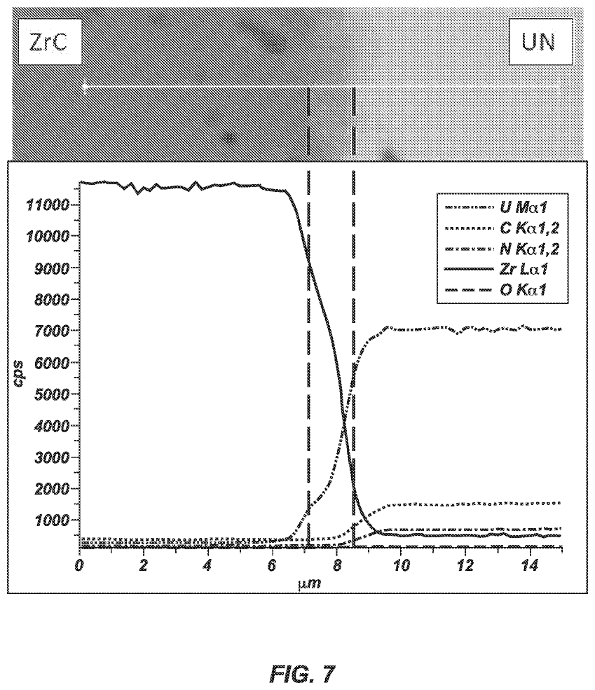

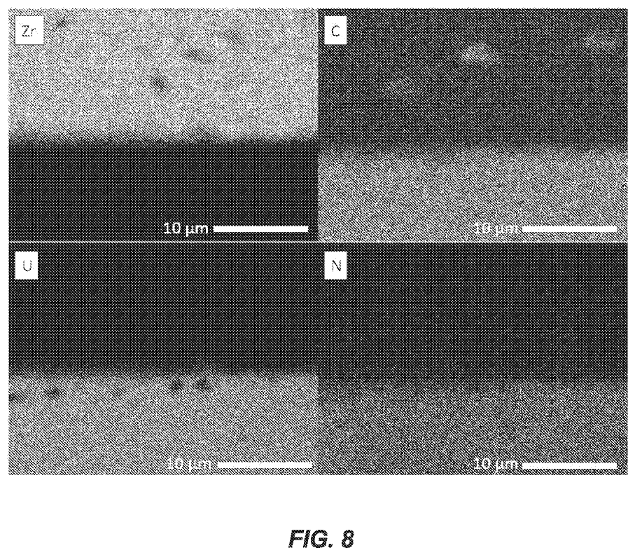

These couples were examined using SEM/EDS to do a preliminary evaluation of the interaction boundary (e.g., the UN/ZrC boundary). EDS maps, as shown in FIGS. 6A and 6B, of one sample showed a diffusion layer (indicated by arrows in FIG. 6B) of approximately 5 μm. There was variation across the sample ranging about ±2 μm. EDS line scans of the second sample also showed a distinct interaction zone that is indicative of a UZr(CN) phase, as shown in FIG. 7. This shows clear but limited diffusion behavior. However, it is difficult to know how the lighter elements (carbon, nitrogen) are behaving because EDS is unreliable for elements lighter than sodium. The preliminary EDS data suggested that the carbon is also migrating into the UN side of the diffusion couple. This behavior was examined using WDS, which is generally more quantitative than EDS because of its wavelength identification mechanism. WDS indicated that there is a UC₁₋ₓNₓ phase occurring with carbon migrating to the UN side, as shown in FIG. 8. Because EDS and WDS have limitations when it comes to resolution and light element analysis, a more nanoscopic approach was taken. TEM and APT were used to examine the diffusion boundary. The TEM analysis determined that the crystal structure of the diffusion phase is FCC with an average lattice parameter of 4.86 Å.

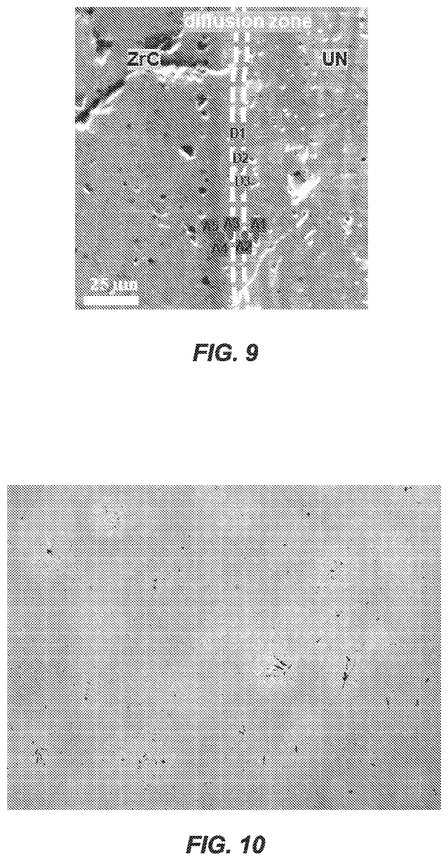

For the APT analysis, specimens were prepared from the diffusion zone and regions close to the diffusion zone as indicated in FIG. 9, with solid circles covering tentative region of lift-out. The regions are indicated in FIG. 9 by D1-D3 (regions of the diffusion zone) and A1-A5. Multiple tips were analyzed from both regions to ensure reproducible chemical quantification is achieved. Making samples in this manner allowed for the systematic investigation of chemical distribution in the different phases around the diffusion zone. All of the datasets collected with APT had a minimum of 50 million counts. The mass spectrum obtained from the UN/ZrC composite was complex due to field evaporation of molecular species involving CN, ZrC, ZrN, UN, and UC ions. Chemical composition from the analyzed volume were calculated using diligent peak assignment and peak deconvolution process using IVAS software. Composition of tips from different regions is provided in Table 1.

TABLE 1
Atomic compositions of U, N, Zr, and C at various
regions across the interaction region in FIG. 9

| Position | D1 | D2 | D3 | A1 | A2 | A3 | A4 | A5 |
|---|---|---|---|---|---|---|---|---|
| U (at %) | 25.55 | 26.15 | 28.23 | 51.08 | 50.35 | 34.70 | 11.10 | N/A |
| N (at %) | 24.16 | 22.33 | 22.81 | 30.70 | 29.30 | 24.62 | 17.43 | 14.27 |
| Zr (at %) | 26.32 | 25.30 | 23.25 | 2.55 | 3.98 | 17.71 | 39.62 | 49.02 |
| C (at %) | 23.34 | 26.05 | 25.60 | 16.12 | 16.24 | 22.68 | 31.80 | 36.33 |

Tips prepared from the center of the diffusion zone (D1-D3) indicated a 1:1:1:1 ratio (U:N:Zr:C), a uniform distribution of all elements, between U:Zr:N:C indicating a quaternary UZr(CN). The observed UZrCN phase was formed between the UN and ZrC materials. Tips prepared from the ZrC side (A3-A5) showed presence of N and U whereas tips prepared from the UN side (A1-A2) indicated slight diffusion of C and Zr. Beyond the interface, there is migration of carbon and nitrogen that creates a tertiary phase of UC₁₋ₓNₓ and ZrCₓN_{y}, which supports the EDS and WDS results.

### Composite Samples

Diffusion behavior of the composite samples was also investigated. Angular fuel composites and spherical (kernel) fuel composites at different fuel volume loadings were tested. The composite samples included 10% by volume UN, 40% by volume UN, or 50% by volume UN, and 50% by volume ZrC, 60% by volume ZrC, or 90% by volume ZrC. The UN and ZrC powders were both mixed thoroughly for 2 hours in a TURBULA® shaker-mixer before being loaded into the DSC-25 die and compressed. The composite samples were considered acceptable if they exceeded 90 percent theoretical density. Density was measured using Archimedes method. Four samples were evaluated in their as-manufactured state. The fuel loading, sintering temperature, hold time, fuel geometry, and pressure were varied between the samples. All samples were ramped up to temperature at 100 °C/min and cooled down at 50 °C/min. These controlled ramps were designed to minimize the damage caused by thermal expansion and contraction. Three of these samples were made with spherical UN particles (e.g., kernels). The four samples were produced using the parameters listed in Table 2.

TABLE 2
Process parameters of the high hold time, high fuel loading, high pressure, and angular fuel samples

| | | | Ramp Up | Hold | Ramp | | | Percent |
|---|---|---|---|---|---|---|---|---|
| | | Sintering | Rate | Time | Down Rate | Pressure | Density | Theoretical |
| Sample ID | Mixture | Temp [°C] | [°C/min] | [min] | [°C/min] | [MPa] | [g/cm³] | Density |
| High hold | 10 vol % | 2100 | 100 | 20 | 50 | 40 | 7.085 | 95% |
| time | kernel UN | | | | | | | |
| | 90 vol % ZrC | | | | | | | |
| High fuel | 50 vol % | 2200 | 100 | 5 | 50 | 40 | 9.594 | 91% |
| loading | kernel UN | | | | | | | |
| | 50 vol % ZrC | | | | | | | |
| High | 10 vol % | 1900 | 100 | 5 | 50 | 80 | 7.01 | 94% |
| pressure | kernel UN | | | | | | | |
| | 90 vol % ZrC | | | | | | | |
| Angular fuel | 40 vol % | 2000 | 100 | 5 | 50 | 40 | 8.991 | 92% |
| | angular UN | | | | | | | |
| | 60 vol % ZrC | | | | | | | |

Since the FAS assembly is capable of creating non-equilibrium phases, heat treatment was performed on the angular fuel sample to determine if the resultant phase was a non-equilibrium phase caused by the FAS or if the phase would persist under conventional heating mechanisms. For direct comparison, the sample was sectioned in a high-speed sample saw to create an as-fabricated sample and a sample for heat treatment. The diffusion behavior was evaluated after fabrication as well as after a high temperature furnace run. The furnace used for this heat treatment was a high temperature tungsten mesh furnace with a nitrogen/argon atmosphere (10 kPa N2). This cover gas was used to protect the furnace from potential sample melt. The sample ran for 8 hours at 2273 K.

The diffusion caused by the FAS manufacturing of three of the samples was found to be mostly dependent on sintering temperature, hold time, and volume fraction of fuel in the composite. The three samples included the high hold time sample, the high pressure sample, and the high fuel loading sample of Table 2. EDS map comparison (not shown) of the three composite samples showed that both the high hold time and high pressure samples (10 volume percent of kernel UN) had a larger interaction region than the high volume sample (50 volume percent of kernel UN). Between the two 10% UN samples, the high hold time sample showed a larger interface region than the high pressure sample.

A study designed to induce the UZrCN phase was conducted and UN and ZrC were mixed in the ratios in Table 3 in powdered form before loading into graphite or tungsten dies and pre-pressed with punches. The powders were dry-milled, ball-milled, or otherwise treated to reduce the particle size to further improve diffusion. The punch and die system were loaded into the FAS and run with the parameters shown in Table 3 to form sintered compacts. For all samples, the pressure was 40 MPa and the pressure rate was 20 MPa/min. The FAS directly controls the temperature, uniaxial pressure, time, ramp rates, and ramping pattern. Current is a result of the temperature set point.

TABLE 3
Process parameters of FAS samples

| | | | | | | Ramp | Hold | |
|---|---|---|---|---|---|---|---|---|
| | Atom % | Atom % | Powder | Die/Punch | Sintering | Rate | Time | Cool Rate |
| Sample | UN | ZrC | Mass [g] | Size [mm] | Temp [C] | [C/min] | [min] | [C/min] |
| 1 | 17.89 | 82.11 | 22.5003 | 15 | 1800 | 100 | 5 | 50 |
| 2 | 17.89 | 82.11 | N/A | 15 | 2000 | 100 | 5 | 50 |
| 3 | 17.89 | 82.11 | 11.0011 | 15 | 2100 | 100 | 5 | 50 |
| 4 | 17.89 | 82.11 | 11.4685 | 15 | 2100 | 250 | 5 | 50 |
| 5 | 50 | 50 | 11.001 | 15 | 2100 | 250 | 5 | 50 |
| 6 | 50 | 50 | 3.5411 | 12 | 2100 | 250 | 5 | 50 |
| 7 | 50 | 50 | 5.0009 | 12 | 2100 | 250 | 5 | 50 |
| 8 | 50 | 50 | 3.5417 | 12 | 2200 | 250 | 5 | 50 |
| 9 | 50 | 50 | 3.5422 | 12 | 2200 | 250 | 5 | 50 |
| 10 | 50 | 50 | 3.545 | 12 | 2200 | 500 | 5 | 50 |
| 11 | 50 | 50 | 3.5434 | 12 | 2200 | 350 | 5 | 50 |
| 12 | 50 | 50 | 3.5056 | 12 | 2100 | 250 | 5 | 50 |
| 13 | 50 | 50 | 3.252 | 12 | 2100 | 250 | 20 | 50 |
| 14 | 20 | 80 | 5.0032 | 12 | 2100 | 250 | 5 | 50 |
| 15 | 50 | 50 | 3.5014 | 12 | 2100 | 100 | 5 | 50 |
| 16 | 20 | 80 | 5.0013 | 12 | 2100 | 100 | 5 | 50 |
| 17 | 20 | 80 | 3.503 | 12 | 2100 | 250 | 5 | 50 |

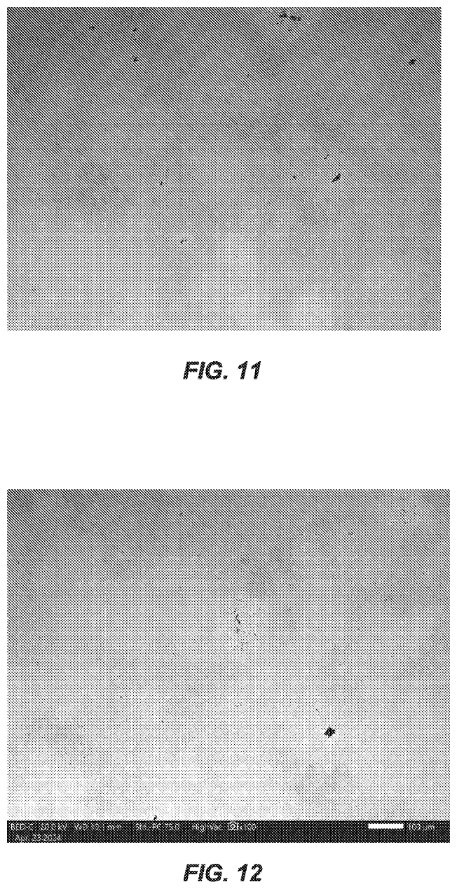

The best diffusion was observed in samples with less than about 50 at % UN. UN concentration and particle size appeared to be the most influential factors in promoting diffusion. SEM images are shown in FIGS. 10, 11, and 12, respectively, for Samples 14, 16, and 17, which included 20 at % UN and 80 at % ZrC. The bulk density by volume for each of these samples was 8.34 g/cm³, 8.35 g/cm³, 8.31 g/cm³, respectively. The % TD density for each sample was 99%. From the above results, UN concentration and particle size influenced diffusion the most.

### Example 2

### Formation of UZrCN by Arc Melting

### General Testing Procedures

Parameters and results for the arc melting process were developed using a Centorr Model 5SA single probe arc melter designed to fabricate research scale alloys. The materials to be alloyed (the casting charge) by the arc melting process were selected and placed within a copper hearth, together forming the anode. An appropriate electrode was selected and fastened within the copper probe, together forming the cathode. Cooling water and power were supplied to the probe, with the power supplied from a conventional welding power supply. The power level was determined by setting the maximum amperage that could be applied to the probe. Once the casting charge was placed within the furnace and the appropriate cover gas established at the appropriate pressure and flow rate, an arc was struck by either using a high frequency starting system to strike the arc from a distance, or by using a lift-start system where an operator placed the electrode on the anode, began to supply power, and then slowly lifted the electrode to establish the arc. Once the arc was established, the amperage and, therefore, temperature of the arc was controlled by a foot pedal. By applying pressure to the pedal, the amperage applied across the cathode and anode increased, such that the full amperage setting was applied when the pedal was completely pressed. With the arc established, the end of the electrode was held a few millimeters away from the casting charge and appropriate power was applied, using the pedal, to achieve melting of the material. During this process, the electrode was moved around the surface of the melt to ensure all material melted and to induce mixing in the melt. Once the desired melt cycle time had been achieved (typically 1-2 minutes per cycle), the arc was disestablished. The sample (e.g., button) formed from the melt was flipped and remelted in the hearth to assist in achieving homogeneity of the casting charge. The process was repeated until the desired total melt duration was achieved. The samples were characterized by EDS, SEM, and XRD.

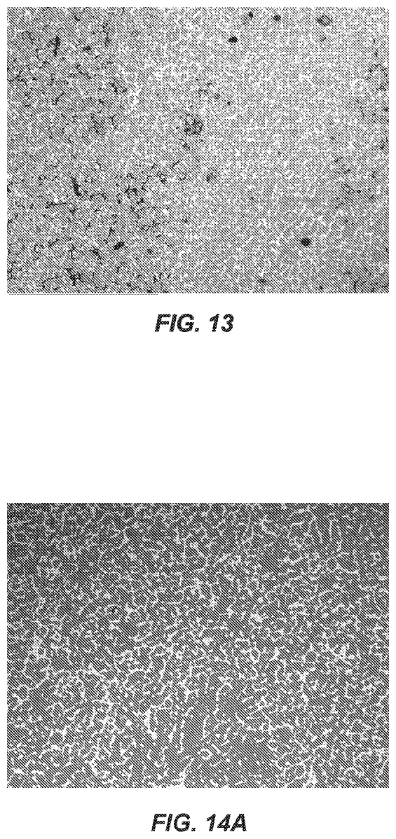

One sample was fabricated by preparing a UZrC composite material by arc melting. The cover gas used during the UZrC composite material formation was argon. The UZrC composite material was remelted in the presence of flowing nitrogen to achieve nitrogen uptake into the UZrC composite material. The nitrogen flow rate was 1 L/min at a nitrogen pressure of 0.5 psi and the amperage was 300 A. The total melt duration was 3 minutes. The amperage was 300 A. The electrode material was tungsten. The alloying order was UZrC, followed by nitrogen. The result was a small, rounded, golden button of UZrCN. The sample evidenced moderate diffusion from uranium with significant zirconium rich regions, as shown in FIG. 13.

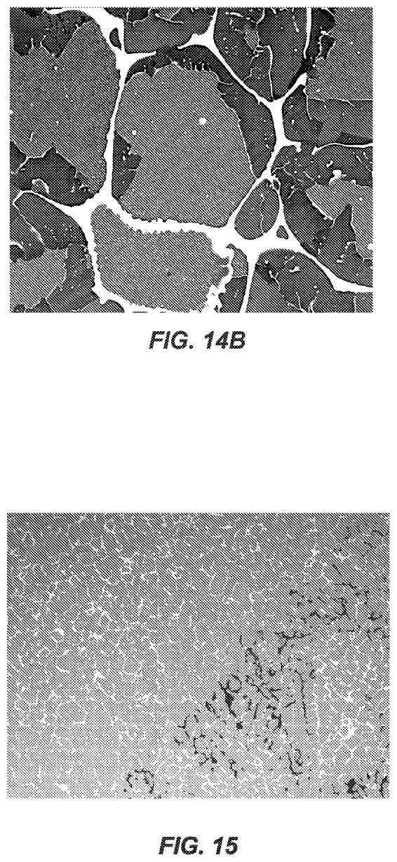

Another sample was fabricated by first preparing a UZr button, which was then remelted under flowing nitrogen to incorporate nitrogen. After forming the UZrN button, the sample was remelted under flowing argon over carbon. The nitrogen flow rate was 2 L/min at a nitrogen pressure of 0.5 psi and the amperage was 300 A. The melt duration was 8.5 minutes to form the UZrN button and about 19 minutes to form the UZrCN, as shown in FIG. 14A. The electrode material was tungsten. The alloying order was UZr, followed by nitrogen, and then by carbon. The sample exhibited signs of decomposition of nitrogen bearing compounds evidenced by small orthorhombic uranium precipitates in otherwise zirconium rich regions, as shown in FIG. 14B. The sample was characterized by XRD.

A third sample was fabricated by first preparing a UZr button, which was then remelted under flowing nitrogen and the addition of carbon. The nitrogen and carbon were added in the same step. The nitrogen flow rate was 1 L/min at a nitrogen pressure of 0.5 psi and the amperage was 300 A. The total melt duration was 4.5 minutes. The electrode material was tungsten. The alloying order was UZr, followed by nitrogen and carbon. Diffusion and prevalence of uranium into zirconium regions improved over the previous samples while still presenting small uranium precipitates, as shown in FIG. 15.

Additional non-limiting example embodiments of the disclosure are described below.

Embodiment 1: A method of producing uranium-zirconium carbonitride comprising: combining uranium nitride and zirconium carbide in a die of a sintering assembly; applying pressure to the combined uranium nitride and zirconium carbide with the die; and applying direct current across the combined uranium nitride and zirconium carbide to form uranium-zirconium carbonitride.

Embodiment 2: The method of Embodiment 1, wherein combining uranium nitride and zirconium carbide in a die of a sintering assembly comprises combining powders of the uranium nitride and the zirconium carbide in the die of the sintering assembly.

Embodiment 3: The method of Embodiment 1 or Embodiment 2, wherein combining uranium nitride and zirconium carbide in a die of a sintering assembly comprises combining uranium nitride and zirconium carbide exhibiting average particle sizes of between about 110 nm and about 300 μm.

Embodiment 4: The method of any of Embodiments 1-3, wherein combining uranium nitride and zirconium carbide in a die of a sintering assembly comprises combining one or more of uranium nitride and zirconium carbide exhibiting an angular morphology.

Embodiment 5: The method of any of Embodiments 1-4, wherein applying pressure to the combined uranium nitride and zirconium carbide with the die and applying direct current across the combined uranium nitride and zirconium carbide comprises forming a quaternary phase of the uranium-zirconium carbonitride.

Embodiment 6: The method of any of Embodiments 1-5, wherein applying pressure to the combined uranium nitride and zirconium carbide and applying direct current across the combined uranium nitride and zirconium carbide to form uranium-zirconium carbonitride comprises forming uranium-zirconium carbonitride having a chemical composition of from U0.1Zr0.9(C0.1N0.9) to U0.9Zr0.1(C0.9N0.1).

Embodiment 7: The method of any of Embodiments 1-6, wherein applying pressure to the combined uranium nitride and zirconium carbide and applying direct current across the combined uranium nitride and zirconium carbide occur substantially simultaneously.

Embodiment 8: The method of any of Embodiments 1-7, wherein applying pressure to the combined uranium nitride and zirconium carbide and applying direct current across the combined uranium nitride and zirconium carbide comprises sintering the combined uranium nitride and zirconium carbide at a temperature of from about 1200 °C to about 2500 °C.

Embodiment 9: A method of producing uranium-zirconium carbonitride comprising: reacting a uranium-zirconium alloy and a cyanide compound to form uranium-zirconium carbonitride.

Embodiment 10: The method of Embodiment 9, wherein reacting a uranium-zirconium alloy with a cyanide compound to form uranium-zirconium carbonitride comprises reacting the uranium-zirconium alloy with a gaseous cyanide compound.

Embodiment 11: The method of Embodiment 9 or Embodiment 10, wherein reacting a uranium-zirconium alloy with a cyanide compound to form uranium-zirconium carbonitride comprises reacting the uranium-zirconium alloy with hydrogen cyanide, cyanogen, or a combination thereof.

Embodiment 12: The method of Embodiment 9 or Embodiment 10, wherein reacting a uranium-zirconium alloy with a cyanide compound to form uranium-zirconium carbonitride comprises reacting the uranium-zirconium alloy with an aqueous solution of the cyanide compound or with a solid cyanide compound.

Embodiment 13: A method of producing uranium-zirconium carbonitride comprising: combining zirconium, uranium, and carbon under a nitrogen atmosphere in an arc melt caster; heating the zirconium, uranium, and carbon to a temperature of greater than or equal to about 3500 °C to form a melt phase comprising zirconium, uranium, carbon, and nitrogen; and cooling the melt phase to form uranium-zirconium carbonitride.

Embodiment 14: The method of Embodiment 13, wherein heating the zirconium, uranium, and carbon to a temperature of greater than or equal to about 3500 °C comprises heating the zirconium, uranium, and graphite.

Embodiment 15: The method of Embodiment 13 or Embodiment 14, wherein combining zirconium, uranium, and carbon under a nitrogen atmosphere comprises layering the carbon between the zirconium and the uranium.

Embodiment 16: The method of any of Embodiments 13-15, wherein heating the zirconium, uranium, and carbon to a temperature of greater than or equal to about 3500 °C comprises heating the zirconium, uranium, and carbon for between about 1 minute and about 5 minutes.

Embodiment 17: The method of any of Embodiments 12-16, further comprising adjusting a flow rate of nitrogen to form the uranium-zirconium carbonitride.

Embodiment 18: A composition comprising uranium-zirconium carbonitride at a purity of greater than or equal to about 99.5%.

Embodiment 19: The composition of Embodiment 18, wherein the uranium-zirconium carbonitride comprises less than or equal to about 0.1% oxygen by mass.

Embodiment 20: The composition of Embodiment 18 or Embodiment 19, wherein the uranium-zirconium carbonitride is U0.25Zr0.25C0.25N0.25.

While the disclosure is susceptible to various modifications and alternative forms, specific embodiments have been shown by way of example in the drawings and examples and have been described in detail herein. However, the disclosure is not limited to the particular forms disclosed. Rather, the disclosure is to cover all modifications, equivalents, and alternatives falling within the scope of the following appended claims and their legal equivalents. For example, elements and features disclosed in relation to one embodiment may be combined with elements and features disclosed in relation to other embodiments of the disclosure.

1. A method of producing uranium-zirconium carbonitride, comprising:
combining uranium nitride and zirconium carbide in a die of a sintering assembly;
applying pressure to the combined uranium nitride and zirconium carbide with the die; and
applying direct current across the combined uranium nitride and zirconium carbide to form uranium-zirconium carbonitride.

2. The method of claim 1, wherein combining uranium nitride and zirconium carbide in a die of a sintering assembly comprises combining powders of the uranium nitride and the zirconium carbide in the die of the sintering assembly.

3. The method of claim 1, wherein combining uranium nitride and zirconium carbide in a die of a sintering assembly comprises combining uranium nitride and zirconium carbide exhibiting average particle sizes of between about 110 nm and about 300 μm.

4. The method of claim 1, wherein combining uranium nitride and zirconium carbide in a die of a sintering assembly comprises combining one or more of uranium nitride and zirconium carbide exhibiting an angular morphology.

5. The method of claim 1, wherein applying pressure to the combined uranium nitride and zirconium carbide with the die and applying direct current across the combined uranium nitride and zirconium carbide comprises forming a quaternary phase of the uranium-zirconium carbonitride.

6. The method of claim 1, wherein applying pressure to the combined uranium nitride and zirconium carbide and applying direct current across the combined uranium nitride and zirconium carbide to form uranium-zirconium carbonitride comprises forming uranium-zirconium carbonitride having a chemical composition of from U_{0.1}Zr_{0.9}(C_{0.1}N_{0.9}) to U_{0.9}Zr_{0.1}(C_{0.9}N_{0.1}).

7. The method of claim 1, wherein applying pressure to the combined uranium nitride and zirconium carbide and applying direct current across the combined uranium nitride and zirconium carbide occur substantially simultaneously.

8. The method of claim 1, wherein applying pressure to the combined uranium nitride and zirconium carbide and applying direct current across the combined uranium nitride and zirconium carbide comprises sintering the combined uranium nitride and zirconium carbide at a temperature of from about 1200 °C to about 2500 °C.

9. A method of producing uranium-zirconium carbonitride, comprising:
reacting a uranium-zirconium alloy and a cyanide compound to form uranium-zirconium carbonitride.

10. The method of claim 9, wherein reacting a uranium-zirconium alloy with a cyanide compound to form uranium-zirconium carbonitride comprises reacting the uranium-zirconium alloy with a gaseous cyanide compound.

11. The method of claim 9, wherein reacting a uranium-zirconium alloy with a cyanide compound to form uranium-zirconium carbonitride comprises reacting the uranium-zirconium alloy with hydrogen cyanide, cyanogen, or a combination thereof.

12. The method of claim 9, wherein reacting a uranium-zirconium alloy with a cyanide compound to form uranium-zirconium carbonitride comprises reacting the uranium-zirconium alloy with an aqueous solution of the cyanide compound or with a solid cyanide compound.

13. A method of producing uranium-zirconium carbonitride, comprising:
combining zirconium, uranium, and carbon under a nitrogen atmosphere in an arc melt caster;
heating the zirconium, uranium, and carbon to a temperature of greater than or equal to about 3500 °C to form a melt phase comprising zirconium, uranium, carbon, and nitrogen; and
cooling the melt phase to form uranium-zirconium carbonitride.

14. The method of claim 13, wherein heating the zirconium, uranium, and carbon to a temperature of greater than or equal to about 3500 °C comprises heating the zirconium, uranium, and graphite.

15. The method of claim 13, wherein combining zirconium, uranium, and carbon under a nitrogen atmosphere comprises layering the carbon between the zirconium and the uranium.

16. The method of claim 13, wherein heating the zirconium, uranium, and carbon to a temperature of greater than or equal to about 3500 °C comprises heating the zirconium, uranium, and carbon for between about 1 minute and about 5 minutes.

17. The method of claim 13, further comprising adjusting a flow rate of nitrogen to form the uranium-zirconium carbonitride.

18. A composition comprising uranium-zirconium carbonitride at a purity of greater than or equal to about 99.5%.

19. The composition of claim 18, wherein the uranium-zirconium carbonitride comprises less than or equal to about 0.1% oxygen by mass.

20. The composition of claim 18, wherein the uranium-zirconium carbonitride comprises U_{0.25}Zr_{0.25}C_{0.25}N_{0.25}.
